(19) United States
(12) Patent Application Publication
(10) Pub. No.: US 2010/0103656 A1
(43) Pub. Date: Apr. 29, 2010

(54) FLASHLIGHT WITH A TELESCOPIC HEAD

(76) Inventor: Yao-Lin Cho, Taichung County (TW)

Correspondence Address: Chien-Hui Su, P. O. Box 70-121 Taichung, Taichung City, 40899, TW

(21) Appl. No.: 12/257,369

(22) Filed: Oct. 23, 2008

(51) Int. Cl. F21L 4/04; F21L 4/00

(52) U.S. Cl. 362/198; 362/208

(57) ABSTRACT

A flashlight with a telescopic head includes a handle having a head mounted on one end thereof. The head has multiple lamps mounted therein. A bouncing mechanism is mounted into the head and has an outer sleeve mounted therein. The bouncing mechanism has a cam body movably received in the outer sleeve. The bouncing mechanism has a rotatory selectively received in the outer sleeve. The rotatory cam has a top for engaging to the outer sleeve. The bouncing mechanism has a spring disposed in the handle. A telescopic rod is received in the head and the bouncing mechanism. The telescopic rod has a head member disposed on one end thereof. The head member has a magnetic head mounted thereon;

### BACKGROUND OF THE INVENTION

1. Field of the Invention

The present invention relates to a flashlight, and more particularly to a flashlight with a telescopic head.

2. Description of Related Art

A conventional flashlight generally includes a cylindrical tube serving as a handle for the conventional flashlight. Two or more dry cell batteries are received in the cylindrical tube for providing electrical energy. An electrical circuit is established from one electrode of the battery through a conductor to a switch, then through a conductor to one electrode of a lamp bulb mounted in a front end of the cylindrical tube. The electrical circuit emerges through a second electrode of the lamp bulb to electrically contact with a conductor for conducting with the other electrode of the battery.

However, the conventional flashlight only provides an illumining effect. When an object, e.g. a sleeve, a screw or a nut, falls in a slit or in a dark nook, the dark nook might be lighted by the conventional flashlight. Therefore, the object still may not be attached. Furthermore, the slit of the dark nook is deeper than a lighting range of the conventional flashlight, the object falling in the slit is hard to be attached.

The present invention has arisen to mitigate and/or obviate the disadvantages of the conventional flashlight.

### SUMMARY OF THE INVENTION

The main objective of the present invention is to provide an improved flashlight with a telescopic head for providing a telescopic rod having a magnetic head for telescopically magnetizing a screw.

To achieve the objective, the flashlight with a telescopic head in accordance with the present invention comprises a handle having a hollow structure for adapting to receive at least one battery. A switch is laterally disposed on the handle. The handle has a head mounted on one end thereof. The head has multiple lamps mounted therein and a transparent cover mounted thereon. A bouncing mechanism is mounted into the head and has an outer sleeve mounted therein. The outer sleeve has multiple guiders equally formed on an inner periphery thereof and multiple grooves defined therein. Each groove is formed between two adjacent guiders. Each guider has a slantwise bottom formed thereon and a slantwise shoulder notched in the slantwise bottom. The bouncing mechanism has a cam body coaxially and movably received in the outer sleeve. The cam body has multiple first flanges formed on an outer periphery thereof and corresponding to the multiple grooves for slidably moving in the outer sleeve along the multiple grooves. The cam body has a series of teeth formed on a bottom thereof. The bouncing mechanism has a rotatory cam coaxially and selectively received in the outer sleeve. The rotatory cam has multiple second flanges formed on an outer periphery thereof for corresponding to the multiple grooves. Each second flange has a top complementally corresponding to the slantwise shoulder of the guider for engaging to the slantwise shoulder. The rotatory cam has a series of second teeth formed on a top thereof. The bouncing mechanism has a spring disposed in the handle for connecting to a bottom of the rotatory cam and an interior of the handle. A telescopic rod is received in the head and the bouncing mechanism and has a head member disposed on one end thereof. The head member is abutted against a top of the cam body and has a magnetic head mounted thereon for adapting to magnetize a screw.

The multiple second flanges are respectively engaged to a corresponding one shoulder of the multiple guiders. The head member is downwardly pressed and abutted against the top of the cam body receiving in the outer sleeve. The series of first teeth of the cam body is downwardly and slantwise engaged with the second teeth of the rotatory cam to rotate the rotatory cam for detaching the multiple second flanges from the corresponding shoulder such that the rotatory cam is received in the outer sleeve and abutted against the cam body due to a restitution force of the spring for protruding the head member from the head.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a flashlight with a telescopic head in accordance with the present invention;

FIG. 2 is an exploded view of a bouncing mechanism of the flashlight with a telescopic head in accordance with the present invention;

FIG. 3 is a perspective view shows the bouncing mechanism received in the head of the flashlight with a telescopic head in accordance with the present invention;

FIG. 4 is an operational view of the flashlight with a telescopic head in accordance with the present invention;

FIG. 5 is a partial cross-sectional side plan view of the bouncing mechanism of the flashlight with a telescopic head in FIG. 3;

FIG. 6 is an operational view of the flashlight with a telescopic head in accordance with the present invention;

FIG. 7 is a partial cross-sectional side plan view of the bouncing mechanism of the flashlight with a telescopic head in FIG. 5; and

FIG. 8 to FIG. 11 are operational views of the flashlight with a telescopic head in accordance with the present invention.

### DETAILED DESCRIPTION OF THE INVENTION

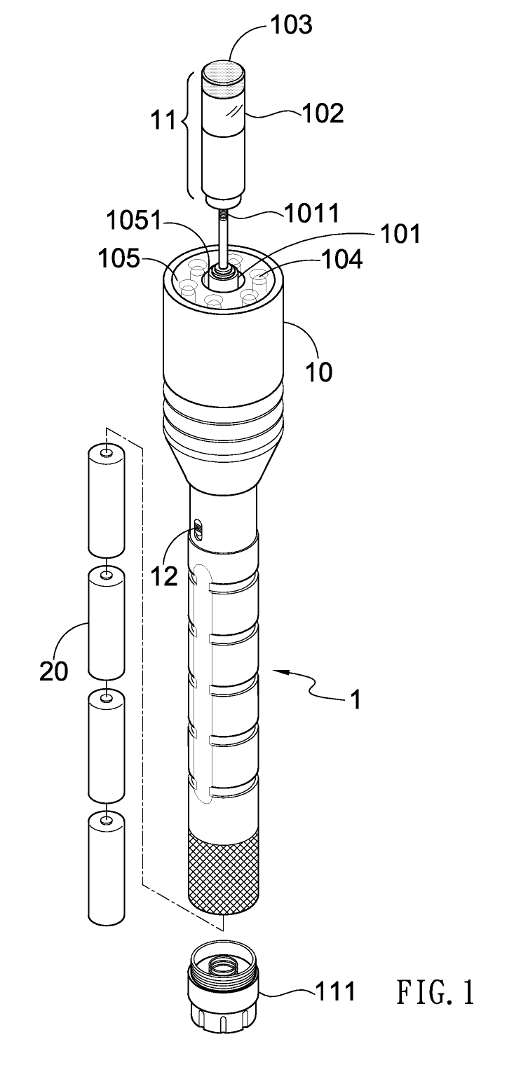

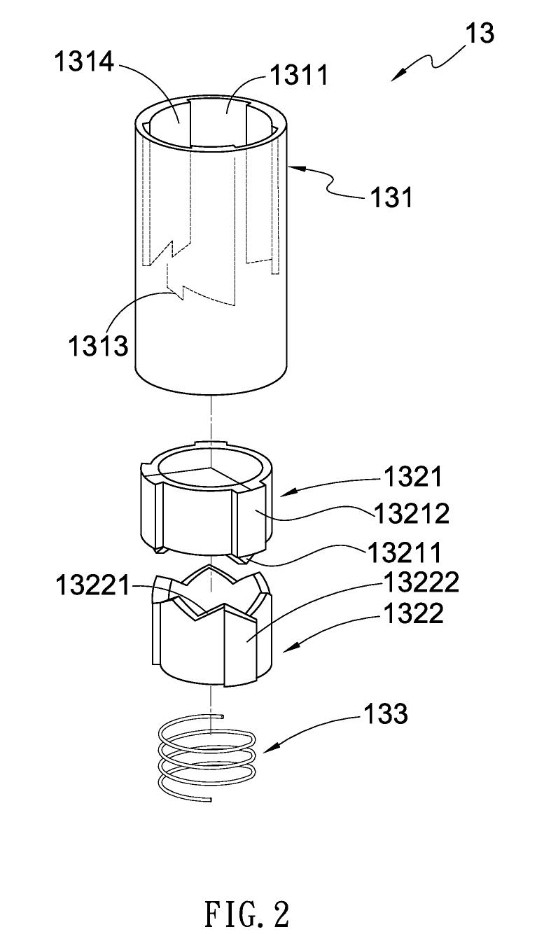

Referring to the drawings and initially to FIGS. 1-3, a flashlight with a telescopic head in accordance with the present invention comprises a handle (1) having a first end and a second end. A head (10) is mounted on the first end of the handle (1) and a bouncing mechanism (13) is mounted into the head (10).

The handle (1) has a hollow structure. At least one battery (20) is received in the handle (1) from the second end of the handle (1). A cap (111) is detachably mounted on the second end of the handle (1). A switch (12) is disposed on an outer periphery of the handle (1) and electrically contacts with the head (10) and the at least one battery (20) for selectively turning on/off the flashlight. The head (10) has multiple lamps (104) mounted therein and a transparent cover (105) mounted thereon such that light projected from the multiple lamps (104) passes through over the transparent cover (105). In the preferred embodiment of the present invention, the multiple lamps (104) are LEDs (Lighting Emitting Diode).The transparent cover (105) has a hole (1051) centrally defined therein for receiving a telescopic rod (101).

The bouncing mechanism (13) has an outer sleeve (131) mounted therein. The outer sleeve (131) has multiple guiders (1314) formed on an inner periphery thereof. Between each two adjacent guiders (1314) has a groove (1311) defined therein to form multiple grooves (1311). Each guider (1314) has a slantwise bottom (1313) formed thereon and a slantwise shoulder (1312) notched in the slantwise bottom (1313). The bouncing mechanism (13) has a cam body (1321) coaxially and slidably received in the outer sleeve (131). The cam body (1321) has multiple first flanges (13212) formed on an outer periphery thereof and corresponding to the multiple grooves (1311) for slidably moving in the outer sleeve (131) along the multiple grooves (1311). The cam body (1321) has a series of first teeth (13211) formed on a bottom thereof. The bouncing mechanism (13) has a rotatory cam (1322) coaxially and selectively received in the outer sleeve (131). The rotatory cam (1322) has multiple second flanges (13222) formed on an outer periphery thereof for slidably moving in the outer sleeve (131) along the multiple grooves (1311). A top of each second flange (13222) has a shape complementally corresponding to a shape of the slantwise shoulder (1312) of the guider (1314) of the outer sleeve (131) for engaging to the slantwise shoulder (1312). The rotatory cam (1322) has a series of second teeth (13221) formed on a top thereof. The bouncing mechanism (13) has a spring (133) connecting to a bottom of the rotatory cam (1322) and the spring (133) is compressively received in the handle (1).

The telescopic rod (101) is received in the hole (1051) in the transparent cover (105) of the head (10) and has one end connected to an interior of the handle (1) via the cam body (1321) and the rotatory cam (1322). The telescopic rod (101) has a head member (not numbered) disposed on the end thereof. An adjusting portion (1011) is disposed between the telescopic rod (101) and the head member and is bendable such that the head member is freely pivotable. The head member is abutted against a top of the cam body (1321). The head member has a lamp portion (102) disposed thereon and a magnetic head (103) disposed on the lamp portion (102) to illuminate in a slit and magnetize a screw. In the preferred embodiment of the present invention, the lamp portion (102) is a LED (Lighting Emitting Diode).

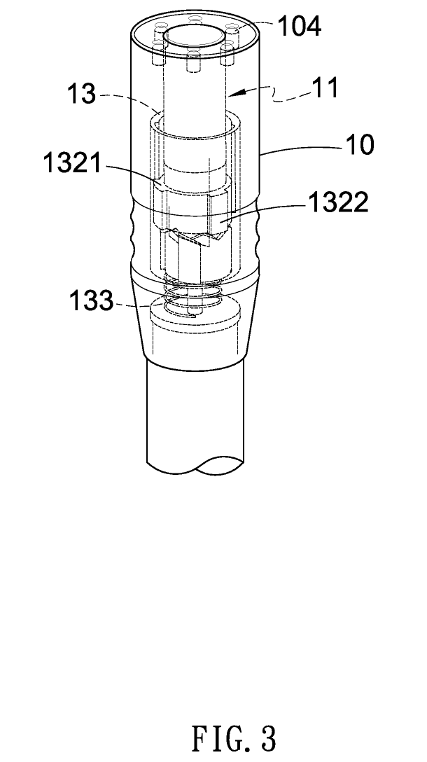

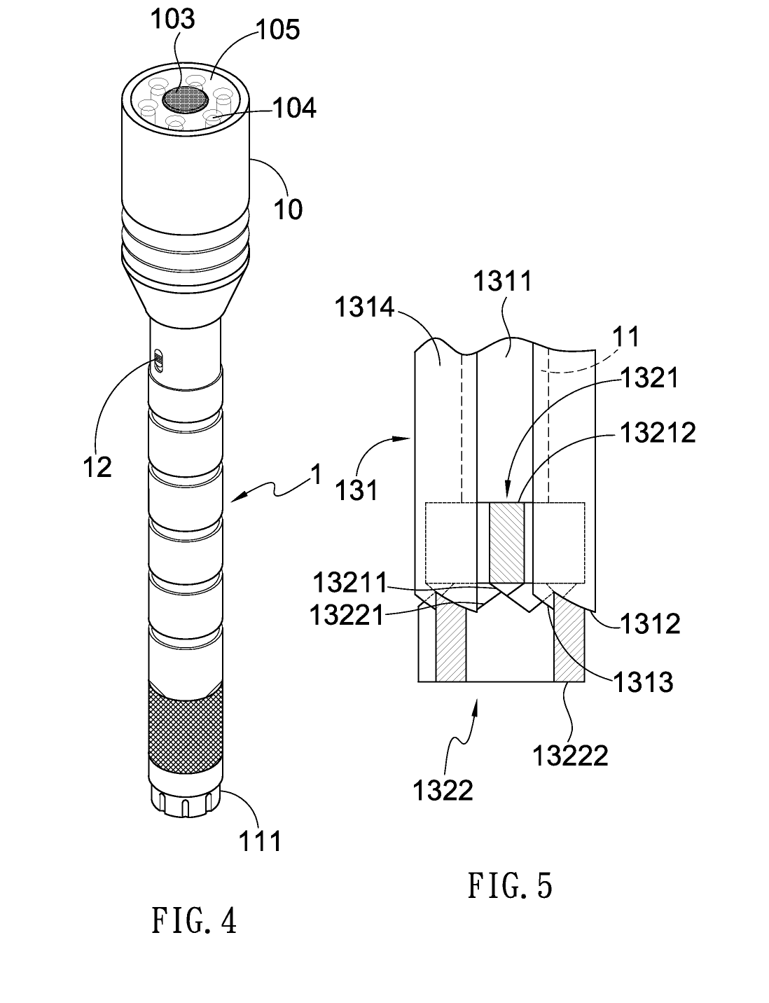

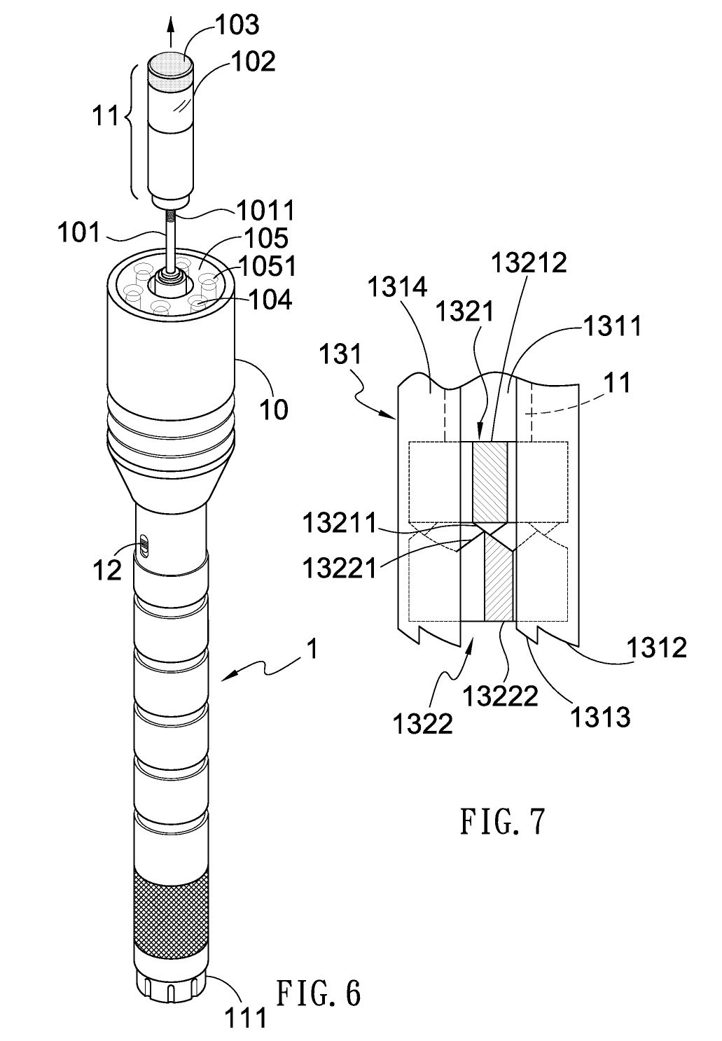

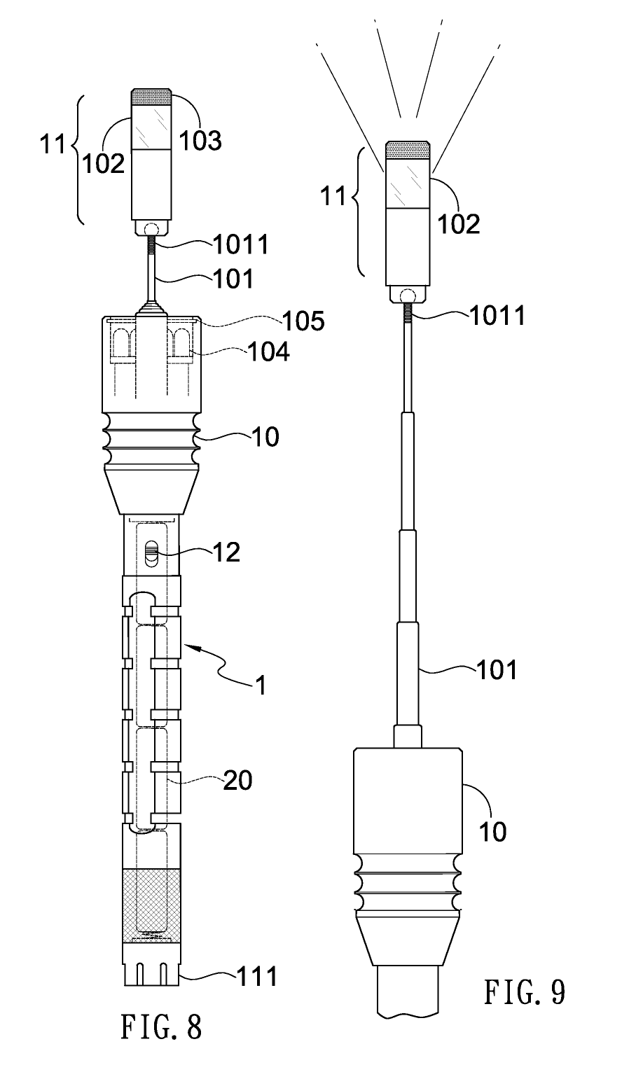

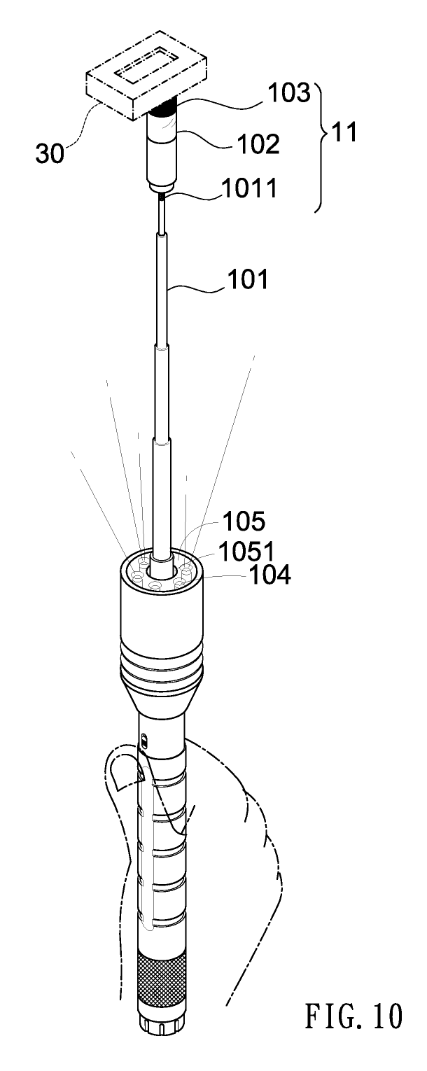

With reference to FIGS. 4-7, the multiple second flanges (13222) of the rotatory cam (1322) are respectively engaged to a corresponding one shoulder (1312) of the multiple guiders (1314) of the outer sleeve (131). As shown in FIGS. 3-4, the cam body (1321) is received in the outer sleeve (131) such that the series of first teeth (13211) of the cam body (1321) does not completely engage with the series of the second teeth (13221) of the rotatory cam (1322) and the telescopic rod (101) is in a closed-position. The cam body (1321) is downwardly moved along the multiple grooves (1311) of the outer sleeve (131) and the series of first teeth (13211) of the cam body (1321) is slantwise engaged with the series of second teeth (13221) of the rotatory cam (1322) when the head member is telescopically and downwardly compressed and the head member is abutted against the top of the cam body (1321). The rotatory cam (1322) is rotated and each second flange (13222) is detached from the corresponding shoulder (1312) due to the series of first teeth (13211) of the cam body (1321) which is slantwise engaged with the series of second teeth (13221) of the rotatory cam (1322). As shown in FIGS. 5-6, the multiple second flanges (13222) are respectively and slidably received in a corresponding one groove (1311) such the rotatory cam (1322) is slidably received in the outer sleeve (131) and the rotatory cam (1322) is abutted against the cam body (1321) due to a restitution force of the spring (133). Therefore, the cam body (1321) is abutted against the head member and the head member is protruded from the transparent cover (105) of the head (10) such that the telescopic rod (101) is in an opened-position. A user could downwardly press the head member and easily extend the telescopic rod (101). Furthermore, the cam body (1321) is downwardly abutted against the rotatory cam (1322). The series of first teeth (13211) is slantwise engaged to the series of second teeth (13221) such that the rotatory cam (1322) is rotated. Each second flange (13222) of the rotatory cam (1322) is received in the shoulder (1312) of the outer sleeve (131) such that the telescopic rod (101) is in the closed-position again when the head member is downwardly pressed.

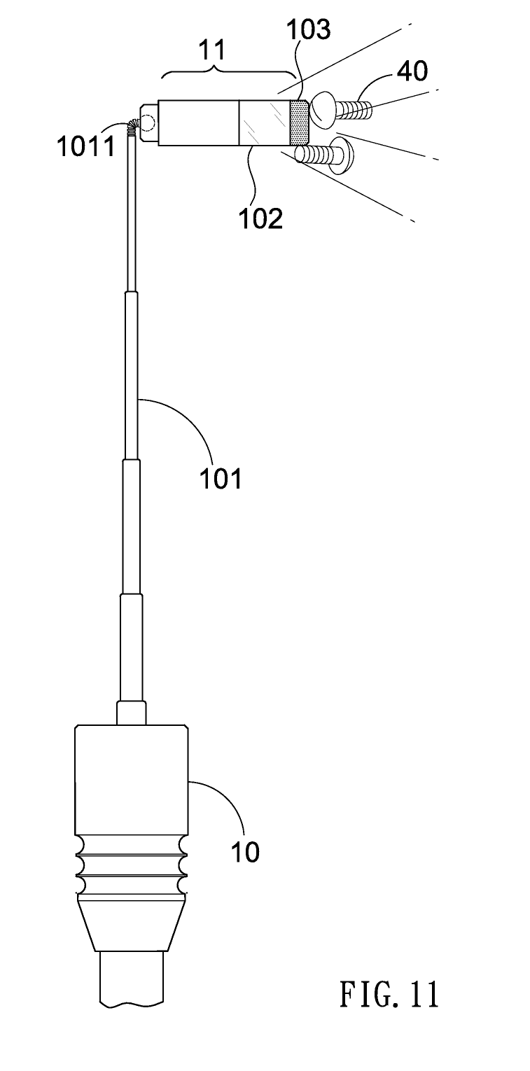

With reference to FIGS. 8-11, the telescopic rod (101) is lengthened for extending the head member into a slit. The lamp portion (102) of the head member projects light for illuminating an interior of the slit. The magnetic head (103) of the head member magnetizes a metal object (30). The multiple lamps (104) could be switched on and illuminate the metal object (30). The adjusting portion (1011) is bent in a specific angle for pivoting the head member and extending the head member into the silt such that the lamp portion (102) illuminates the interior of the slit and the magnetic head (103) easily magnetizes screws (40) fell in the silt.

Although the invention has been explained in relation to its preferred embodiment, it is to be understood that many other possible modifications and variations can be made without departing from the spirit and scope of the invention as hereinafter claimed.

What is claimed is:

1. A flashlight with a telescopic head comprising:
a handle having a hollow structure for adapting to receive at least one battery, a switch laterally disposed on the handle, the handle having a head mounted on one end thereof, the head having multiple lamps mounted therein and a transparent cover mounted thereon;
a bouncing mechanism mounted into the head and having an outer sleeve mounted therein, the outer sleeve having multiple guiders equally formed on an inner periphery thereof and multiple grooves defined therein, each groove formed between two adjacent guiders, each guider having a slantwise bottom formed thereon and a slantwise shoulder notched in the slantwise bottom, the bouncing mechanism having a cam body coaxially and movably received in the outer sleeve, the cam body having multiple first flanges formed on an outer periphery thereof and corresponding to the multiple grooves for slidably moving in the outer sleeve along the multiple grooves, the cam body having a series of teeth formed on a bottom thereof, the bouncing mechanism having a rotatory cam coaxially and selectively received in the outer sleeve, the rotatory cam having multiple second flanges formed on an outer periphery thereof for corresponding to the multiple grooves, each second flange having a top complementally corresponding to the slantwise shoulder of the guider for engaging to the slantwise shoulder, the rotatory cam having a series of second teeth formed on a top thereof, the bouncing mechanism having a spring disposed in the handle for connecting to a bottom of the rotatory cam and an interior of the handle; and
a telescopic rod received in the head and the bouncing mechanism, the telescopic rod having a head member disposed on one end thereof, the head member abutted against a top of the cam body and having a magnetic head mounted thereon for adapting to magnetize a screw;
wherein the multiple second flanges respectively engaged to a corresponding one shoulder of the multiple guiders, the head member downwardly pressed and abutted against the top of the cam body receiving in the outer sleeve, the series of first teeth of the cam body downwardly and slantwise engaged with the second teeth of the rotatory cam to rotate the rotatory cam for detaching the multiple second flanges from the corresponding shoulder such that the rotatory cam is received in the outer sleeve and abutted against the cam body due to a restitution force of the spring for protruding the head member from the head.

2. The flashlight with a telescopic head as claimed in claim 1 the head member further comprising a lamp portion disposed thereon for providing an illumination effect.

3. The flashlight with a telescopic head as claimed in claim 1 further comprising an adjusting portion disposed between the telescopic rod and the head member and being bendable for freely pivoting the head member.

4. The flashlight with a telescopic head as claimed in claim 1, wherein the transparent cover has a hole centrally defined therein for receiving the telescopic rod.
